(19) United States
(12) Patent Application Publication
(10) Pub. No.: US 2012/0243210 A1
(43) Pub. Date: Sep. 27, 2012

(54) Multi Purpose Illuminated Helmet Shell

(75) Inventor: Stephron D. Brown, Gallatin, TN (US)

(73) Assignee: Stephron Deshron Brown, Gallatin, TN (US)

(21) Appl. No.: 13/342,956

(22) Filed: Jan. 3, 2012

Related U.S. Application Data
(60) Provisional application No. 61/465,754, filed on Mar. 24, 2011.

(51) Int. Cl. F21V 21/084

(52) U.S. Cl. 362/106

(57) ABSTRACT

A multiply purpose helmet shell that has more than one light emitting diodes that is embedded in the shell. The helmet shell is designed and constructed in such a way to give visual identification to the wearer. The multiply purpose helmet shell lighting system is powered by battery and other lithium-ion or dry cell batteries that can be mounted within or on the helmet shell; and the lighting system can be turned on and off manually or automatically.

### FIELD OF INVENTIONS

This invention is a helmet shell that has light emitting diodes embedded in the shell structure or light emitting diode flex strips on the exterior shell surface to give sudden identification to the wearer.

### BACKGROUND OF INFORMATION

This invention provides light emitting diodes of florescent lighting that is mounted on the user's body including head covering such as U.S. Pat. No. 4,945,458, the invention presents and illustrates a safety helmet with a lighting device that is in the shell which lights up such as U.S. Pat. No. 7,901,104.

### DETAILED DESCRIPTION

Referring now to the drawings;

FIG. 1A generally illustrates one embodiment of illuminated helmet shell 3 includes on front 1 and a back 2. The front in one embodiment includes front top of shell C. The helmet shell 1 includes an outer surface 3 in one embodiment, outer surface define and outer shell, surface of the helmet. The helmet shell in some embodiments includes a plurality of light emitting diodes strip or just light emitting diodes 4 embedded in the helmet shell 3, as seen in one embodiment illustrated in FIG. 1B, light emitting diode 4 is embedded in a hole 5 defined in the helmet shell 3. Each hole can be molded or drilled in the helmet shell 3.

Also seen in FIG. 2A in some embodiments helmet shell 3 includes a switch 6 hole extending through the helmet shell 3, in one embodiment a switch 6 is disposed on the helmet shell 3.

Referring now to FIG. 1B, the helmet shell 3 includes a recessed 8 off set in the helmet shell 3, where the lens 9 can cover the light emitting diodes 4, to protect it from water or any other damaging optical.

### BRIEF DESCRIPTION OF THE DRAWINGS

FIG. 1A illustrates a partially broken away view of one embodiment of a helmet shell.

FIG. 1B illustrates a detail perspective view of one embodiment of a helmet shell.

FIG. 2 illustrates a partially exploded view of one embodiment of a helmet shell.

FIG. 3 illustrates a broke away shell view of where the removable battery pack is located in the interior shell wall.

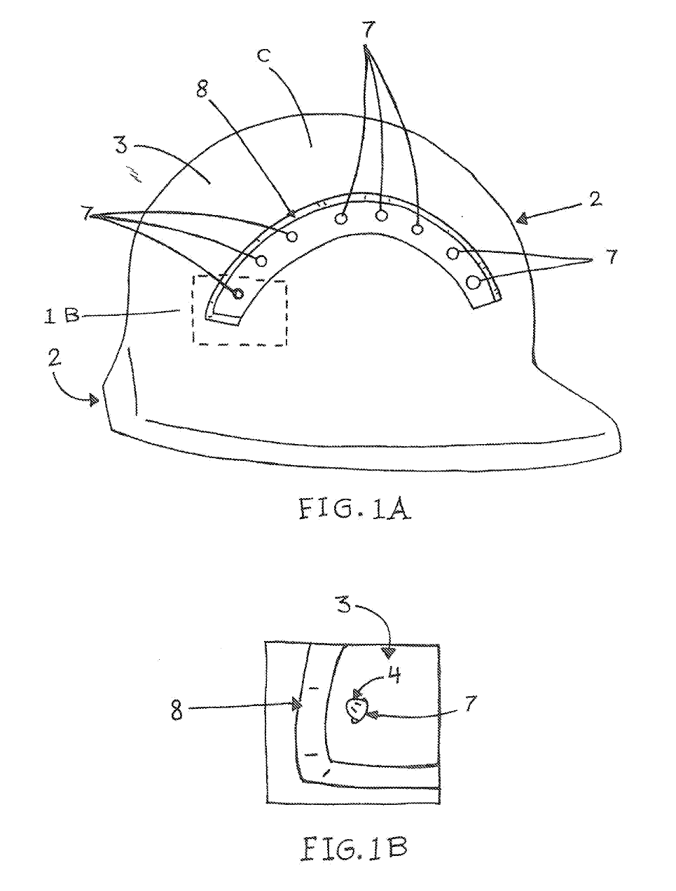

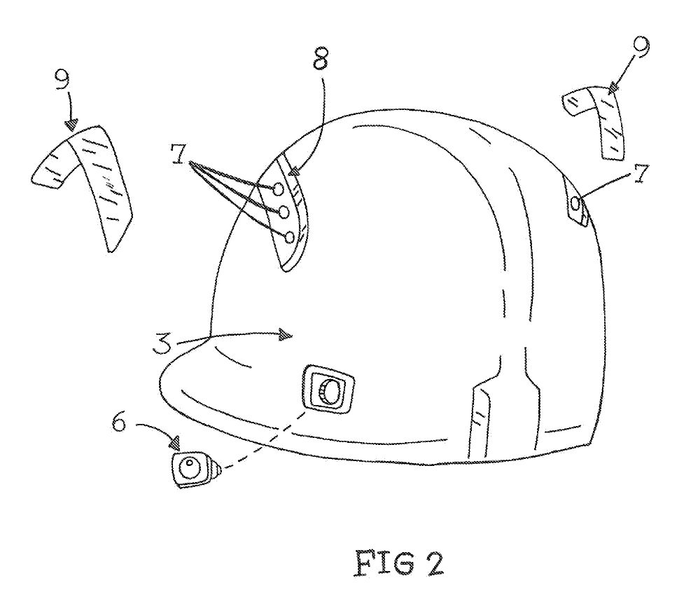

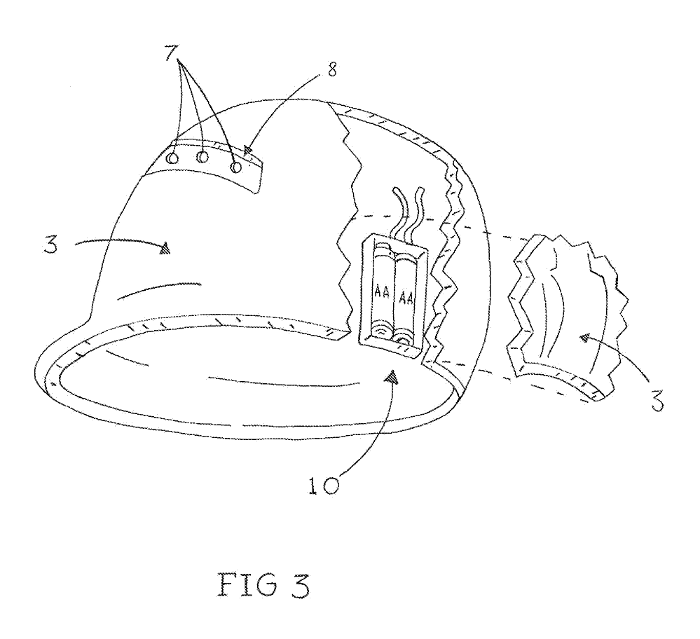

What is claimed is:

1. A helmet shell device for multi-use in different helmets. The device comprising:
a helmet shell having an interior shell surface and an exterior shell surface; the helmet shell defining at least one mounting hole extending through the shell; a first light emitting diode rigidly embedded in the mounting hole;
a power supply disposed inside the helmet shell, the power supply electrically connected to the first light emitting diode and an electrically conductive connector wire disposed on the interior shell surface electrically connecting the power source and the first light emitting diode.

2. The device of claim 1, further comprising: the power supply having first and second power wires that's connected to the first and second diode terminals:

3. The device of claim 2, further comprising the first wire that is connected to the negative side of the light emitting diode.

4. The device of claim 2, further comprising the second wire that is connected to the positive side of the light emitting diode.

5. The device of claim 1, further comprising water proofing glue or sealant disposed in the hole surrounding the light emitting diode.

6. The device of claim 1, further comprising a recessed shape embedded in the structure of the helmet shell that allows the light emitting diode flex stripes to be mounted to the shell in different shapes and sizes.

7. The device of claim 6, further comprising a first lens disposed on the exterior shell surface wherein the first lens covers the recessed that is embedded with light emitting diodes or light emitting diode flex stripes.

8. The device of claim 7, wherein the first lens includes a first color.

9. The device of claim 7, further comprising a second lens deposit on the exterior shell surface wherein the first lens covers the recessed that is embedded with light emitting diodes or light emitting diode flex strips.

10. The device of claim 1, further comprising different materials that the shell can be constructed of such as Kevlar, carbon fiber, fiberglass, rubber and plastics.

11. The device of claim 1, further comprising usage of florescent light panels that also can be embedded in different recessed shapes into the helmet shell.

12. The device of claim 1, further comprising the use of claim 1 in different helmets, for skateboarding, hiking, mountain climbing, military, snowboarding, construction snow mobiles, skiing and bicycles.

13. The device of claim 1, further comprising battery housing formed in the helmet shell: a removable battery pack disposed in battery housing, the battery pack including at least one battery but not limited to one.

14. The device of claim 1, further comprising a switch mounting hole extending through the helmet shell.

15. The device of claim 1, further comprising a switch of at least one type but not limited to one switch type.

16. The device of claim 1, further comprising a LED holder that allows the LED to be mounted through the helmet shell.
